(19) United States
(12) Patent Application Publication
(10) Pub. No.: US 2014/0372090 A1
(43) Pub. Date: Dec. 18, 2014

(54) INCREMENTAL RESPONSE MODELING

(71) Applicant: SAS Institute Inc., Cary, NC (US)

(72) Inventors: Taiyeong Lee, Cary, NC (US); Ruiwen Zhang, Cary, NC (US); Yongqiao Xiao, Cary, NC (US); Jared Langford Dean, Cary, NC (US)

(73) Assignee: SAS Institute Inc., Cary, NC (US)

(21) Appl. No.: 14/199,409

(22) Filed: Mar. 6, 2014

Related U.S. Application Data
(60) Provisional application No. 61/835,143, filed on Jun. 14, 2013.

(51) Int. Cl. G06F 17/50

(52) U.S. Cl. CPC G06F 17/5009
USPC 703/2

(57) ABSTRACT

A method of selecting a one-class support vector machine (SVM) model for incremental response modeling is provided. Exposure group data generated from first responses by an exposure group receiving a request to respond is received. Control group data generated from second responses by a control group not receiving the request to respond is received. A response is either positive or negative. A one-class SVM model is defined using the positive responses in the control group data and an upper bound parameter value. The defined one-class SVM model is executed with the identified positive responses from the exposure group data. An error value is determined based on execution of the defined one-class SVM model. A final one-class SVM model is selected by validating the defined one-class SVM model using the determined error value.

### CROSS-REFERENCE TO RELATED APPLICATIONS

The present application claims priority under 35 U.S.C. §119(e) to U.S. Provisional Patent Application No. 61/835,143 filed Jun. 14, 2013, the entire contents of which are hereby incorporated by reference.

### BACKGROUND

Direct marketing campaigns that use conventional predictive models target all customers who are likely to buy a product. This approach may waste money on customers who will buy regardless of the marketing contact, however.

### SUMMARY

In an example embodiment, a method of selecting a one-class support vector machine (SVM) model for incremental response modeling is provided. Exposure group data generated from first responses by an exposure group is received. The exposure group received a request to respond. A response of the first responses is either positive or negative. Control group data generated from second responses by a control group is received. The control group did not receive the request to respond. A response of the second responses is either positive or negative. The positive responses in the control group data are identified. The positive responses in the exposure group data are identified. A one-class SVM model is defined using the positive responses from the control group data and an upper bound parameter value. The defined one-class SVM model is executed with the identified positive responses from the exposure group data. An error value is determined based on execution of the defined one-class SVM model. A final one-class SVM model is selected by validating the defined one-class SVM model using the determined error value.

In another example embodiment, a computer-readable medium is provided having stored thereon computer-readable instructions that, when executed by a computing device, cause the computing device to perform the method of selecting a one-class SVM model for incremental response modeling.

In yet another example embodiment, a computing device is provided. The system includes, but is not limited to, a processor and a computer-readable medium operably coupled to the processor. The computer-readable medium has instructions stored thereon that, when executed by the computing device, cause the computing device to perform the method of selecting a one-class SVM model for incremental response modeling.

In still another example embodiment, a method of identifying outliers in data for incremental response modeling is provided. Exposure group data generated from responses by an exposure group is received. The exposure group received a request to respond. A response of the responses is either positive or negative. Control group data generated from second responses by a control group is received. The control group did not receive the request to respond. A response of the second responses is either positive or negative. The positive responses from the control group data are identified. The positive responses from the exposure group data are identified. A classification model is defined using the identified positive responses from the control group data. The defined classification model is executed with the identified positive responses from the exposure group data. An error value is determined based on execution of the defined classification model. A final classification model is selected by validating the defined classification model using the determined error value. A binary classification model is defined using the exposure group data. The defined binary classification model is executed with received data to predict positive responses and negative responses. The selected final classification model is executed with the predicted positive responses of the received data to define outliers. An incremental response is determined as the defined outliers. The incremental response comprises respondents that provide a positive response only when the request to respond is received.

In another example embodiment, a computer-readable medium is provided having stored thereon computer-readable instructions that, when executed by a computing device, cause the computing device to perform the method of identifying outliers in data for incremental response modeling.

In yet another example embodiment, a computing device is provided. The system includes, but is not limited to, a processor and a computer-readable medium operably coupled to the processor. The computer-readable medium has instructions stored thereon that, when executed by the computing device, cause the computing device to perform the method of identifying outliers in data for incremental response modeling.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of an incremental response modeling device in accordance with an illustrative embodiment.

FIG. 2-4 depict flow diagrams illustrating examples of operations performed by the incremental response modeling device of FIG. 1 to determine a one-class support vector machine (SVM) in accordance with illustrative embodiments.

FIG. 5 depicts a flow diagram illustrating examples of operations performed by the incremental response modeling device of FIG. 1 to determine a binary SVM in accordance with an illustrative embodiment.

FIG. 6 depicts a flow diagram illustrating examples of operations performed by the incremental response modeling device of FIG. 1 to determine an incremental response in data in accordance with an illustrative embodiment.

FIG. 7 illustrates response groups and an incremental response in accordance with an illustrative embodiment.

FIG. 8 illustrates selection of a one-class SVM model in accordance with an illustrative embodiment.

FIG. 9 illustrates predicted respondents and non-respondents in accordance with an illustrative embodiment.

FIG. 10 illustrates identification of an incremental response in accordance with an illustrative embodiment.

FIG. 11 depicts a flow diagram illustrating examples of operations performed by the incremental response modeling device of FIG. 1 to determine an incremental response in data in accordance with a second illustrative embodiment.

### DETAILED DESCRIPTION

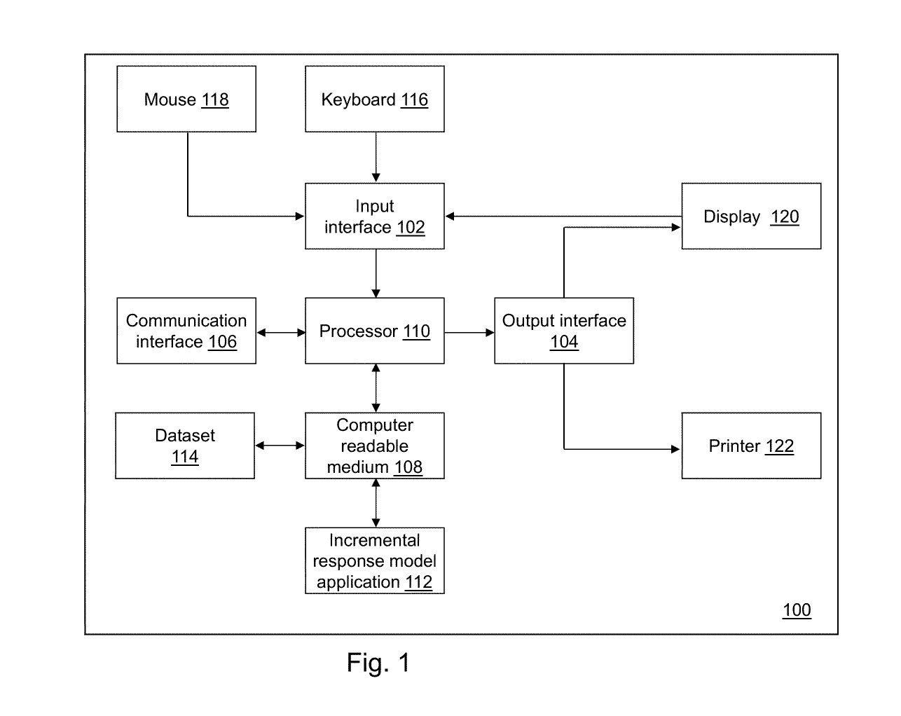

Referring to FIG. 1, a block diagram of an incremental response modeling device 100 is shown in accordance with an illustrative embodiment. Incremental response modeling device 100 may include an input interface 102, an output interface 104, a communication interface 106, a computer-readable medium 108, a processor 110, an incremental response modeling application 112, and dataset 114. Fewer, different, and/or additional components may be incorporated into incremental response modeling device 100.

Input interface 102 provides an interface for receiving information from the user for entry into incremental response modeling device 100 as understood by those skilled in the art. Input interface 102 may interface with various input technologies including, but not limited to, a keyboard 116, a mouse 118, a display 120, a track ball, a keypad, a microphone, one or more buttons, etc. to allow the user to enter information into incremental response modeling device 100 or to make selections presented in a user interface displayed on the display. The same interface may support both input interface 102 and output interface 104. For example, a display comprising a touch screen both allows user input and presents output to the user. Incremental response modeling device 100 may have one or more input interfaces that use the same or a different input interface technology. The input interface technology further may be accessible by incremental response modeling device 100 through communication interface 106.

Output interface 104 provides an interface for outputting information for review by a user of incremental response modeling device 100. For example, output interface 104 may interface with various output technologies including, but not limited to, display 120, a printer 122, etc. Incremental response modeling device 100 may have one or more output interfaces that use the same or a different output interface technology. The output interface technology further may be accessible by incremental response modeling device 100 through communication interface 106.

Communication interface 106 provides an interface for receiving and transmitting data between devices using various protocols, transmission technologies, and media as understood by those skilled in the art. Communication interface 106 may support communication using various transmission media that may be wired and/or wireless. Incremental response modeling device 100 may have one or more communication interfaces that use the same or a different communication interface technology. For example, incremental response modeling device 100 may support communication using an Ethernet port, a Bluetooth antenna, a telephone jack, a USB port, etc. Data and messages may be transferred between incremental response modeling device 100 and a grid control device 130 and/or grid systems 132 using communication interface 106.

Computer-readable medium 108 is an electronic holding place or storage for information so the information can be accessed by processor 110 as understood by those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. Incremental response modeling device 100 may have one or more computer-readable media that use the same or a different memory media technology. Incremental response modeling device 100 also may have one or more drives that support the loading of a memory media such as a CD, DVD, an external hard drive, etc. One or more external hard drives further may be connected to incremental response modeling device 100 using communication interface 106.

Processor 110 executes instructions as understood by those skilled in the art. The instructions may be carried out by a special purpose computer, logic circuits, or hardware circuits. Processor 110 may be implemented in hardware and/or firmware. Processor 110 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 110 operably couples with input interface 102, with output interface 104, with communication interface 106, and with computer-readable medium 108 to receive, to send, and to process information. Processor 110 may retrieve a set of instructions from a permanent memory device and copy the instructions in an executable form to a temporary memory device that is generally some form of RAM. Incremental response modeling device 100 may include a plurality of processors that use the same or a different processing technology.

Incremental response modeling application 112 performs operations associated with determining an incremental response from dataset 114. Some or all of the operations described herein may be embodied in incremental response modeling application 112. The operations may be implemented using hardware, firmware, software, or any combination of these methods. Referring to the example embodiment of FIG. 1, incremental response modeling application 112 is implemented in software (comprised of computer-readable and/or computer-executable instructions) stored in computer-readable medium 108 and accessible by processor 110 for execution of the instructions that embody the operations of incremental response modeling application 112. Incremental response modeling application 112 may be written using one or more programming languages, assembly languages, scripting languages, etc.

Incremental response modeling application 112 may be implemented as a Web application. For example, incremental response modeling application 112 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Dataset 114 may be stored in computer-readable medium 108 and/or on one or more other computing devices and accessed using communication interface 106. For example, dataset 114 may be stored in a cube distributed across a grid of computers as understood by a person of skill in the art. Dataset 114 may be stored using various formats as known to those skilled in the art including a file, a file system, a relational database, a system of tables, a structured query language database, etc. Dataset 114 includes a plurality of observations (rows) based on one or more data variables (columns). Of course, dataset 114 may be transposed.

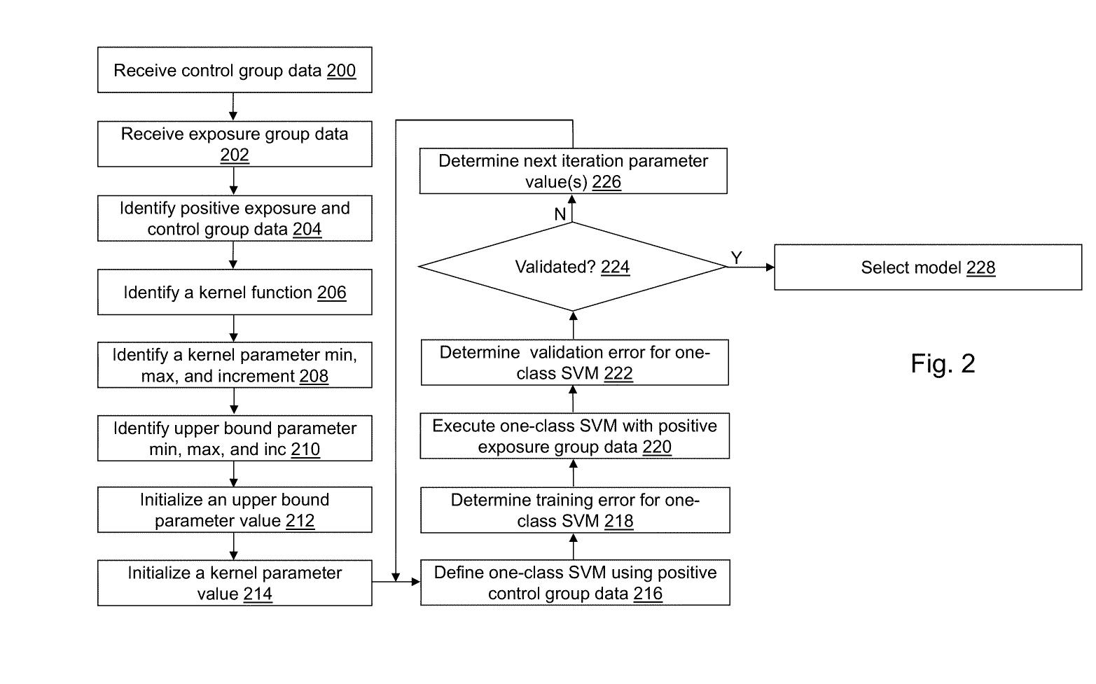

Referring to FIGS. 2-4, examples of operations performed by incremental response modeling application 112 to determine a one-class support vector machine model (SVM) are shown. Referring to FIG. 2, example operations associated with incremental response modeling application 112 are described in accordance with a first illustrative embodiment. Additional, fewer, or different operations may be performed depending on the embodiment. The order of presentation of the operations of FIG. 2 is not intended to be limiting. Although some of the operational flows are presented in sequence, the various operations may be performed in various repetitions, concurrently (in parallel, for example, using threads), and/or in other orders than those that are illustrated. For example, a user may execute incremental response modeling application 112, which causes presentation of a first user interface window, which may include a plurality of menus and selectors such as drop down menus, buttons, text boxes, hyperlinks, etc. associated with incremental response modeling application 112 as understood by a person of skill in the art. As used herein, an indicator indicates one or more user selections from a user interface, one or more data entries into a data field of the user interface, one or more data items read from computer-readable medium 108 or otherwise defined with one or more default values, etc.

An incremental response model uses two randomly selected data sets that may be termed control group data and exposure group data. In an operation 200, control group data is received. As an example, the control group data may be selected by a user using a user interface window and received by incremental response modeling application 112 by reading one or more files, through one or more user interface windows, etc. An indicator of the control group data that indicates, for example, a location of dataset 114 may be received. The indicator may be received by incremental response modeling application 112 after selection from a user interface window or after entry by a user into a user interface window. The control group data may be stored in computer-readable medium 108 and received by retrieving the control group data from the appropriate memory location as understood by a person of skill in the art.

The indicator of control group data may further indicate the control group data as a subset of the data stored in dataset 114. For example, the control group data may be received by selecting samples from dataset 114. The indicator of control group data may indicate a number of observations to include from dataset 114, a percentage of observations of the entire dataset to include from dataset 114, etc. A subset may be created from dataset 114 by sampling. An example sampling algorithm is uniform sampling. Other random sampling algorithms may be used. Additionally, only a subset of the data points (columns or variables) for each observation may be used to determine the incremental response. The indicator of control group data also may indicate a subset of the observations to use to determine the incremental response.

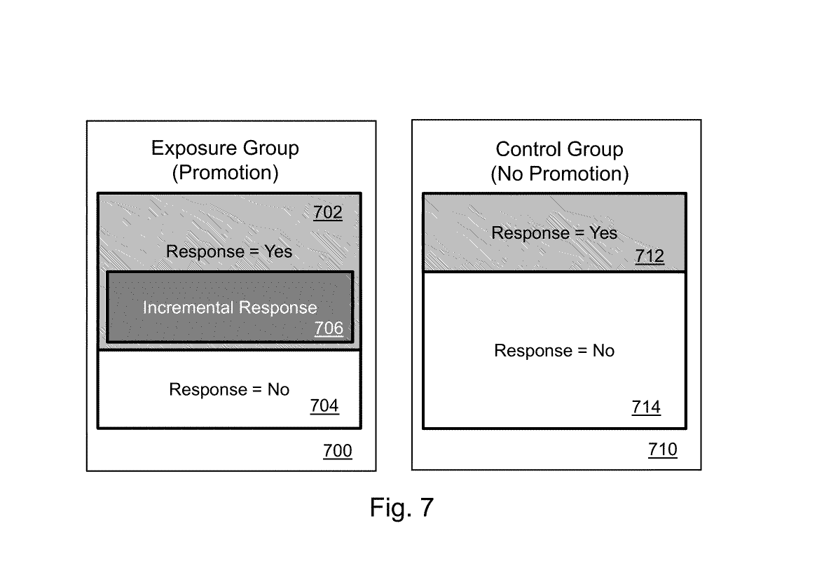

Similar to operation 200, in an operation 202, exposure group data is received. For illustration, referring to FIG. 7, response groups and an incremental response are illustrated. Exposure group data 700 includes positive responses 702 and negative responses 704. Control group data 710 includes positive responses 712 and negative responses 714.

Respondents in exposure group data 700 received a request to respond such as an offer, promotion, or other information implicitly or explicitly requesting an action by the respondent. As an example, the respondents in exposure group data 700 may receive a brochure, an advertisement, a solicitation, or other information related to a product, a service, a store, a candidate, etc. The request to respond may include an implicit or explicit request to respond to the brochure, advertisement or other information. For example, the advertisement may include an implicit request to purchase the advertised product or an explicit request to vote for a candidate. The request to respond may take many forms including electronic, auditory, visual, print media, etc.

Respondents in control group data 710 did not receive a request to respond such as an offer, promotion, or other information. Whether or not a response is positive is based on the context. For example, if the request to respond presents negative information about a candidate or product, a positive response is that the voter did not vote for the candidate or did not purchase the product.

Positive responses 702 of exposure group data 700 and positive responses 712 of control group data 710 indicate that the response or action was taken by the respective respondent. For example, a positive response may indicate the respondent voted for a candidate or purchased a product. Negative responses 704 of exposure group data 700 and positive responses 714 of control group data 710 indicate that a response or action was not taken by a respondent. For example, a negative response may indicate the respondent did not vote for the candidate or purchase the product.

Positive responses 702 of exposure group data 700 may include one or more incremental responses 706. The one or more incremental responses 706 identify positive respondents who provided a positive response only when the request to respond was received. As a result, without receiving the request to respond, the one or more incremental responses 706 would be included in negative responses 704.

Positive responses 712 of control group data 710 are spontaneous positive respondents because positive responses 712 of control group data 710 resulted without receiving the request to respond. For example, positive responses 712 of control group data 710 may represent voters who vote for a candidate without receiving a request to vote for the candidate. As another example, positive responses 712 of control group data 710 may represent consumers who purchase a product without receiving or being exposed to an advertisement related to the product.

Dataset 114 includes a data variable that identifies the response, positive or negative, by the respondent associated with the observation. Dataset 114 further includes a second data variable that identifies whether or not the respondent associated with the observation was exposed to a request to respond such as an advertisement. For example, a first column of dataset 114 indicates the response, positive or negative, and a second column of dataset 114 indicates whether or not the respondent received the request to respond. Control group data 710 may be selected from dataset 113 by only including respondents that did not receive the request to respond based on the value of the second column of dataset 114.

In an operation 204, positive exposure group data and positive control group data are identified. For example, first positive responses are identified in the exposure group control data, and second positive responses are identified in the control group control data.

In an operation 206, a kernel function is identified. For example, an indicator of the kernel function identifying the kernel function to apply is received. For example, the indicator of the kernel function indicates a name of a kernel function. The indicator of the kernel function may be received by incremental response modeling application 112 after selection from a user interface window or after entry by a user into a user interface window. A default value for the indicator of the kernel function to apply may further be stored, for example, in computer-readable medium 108 and identified by reading from the appropriate memory location. In an alternative embodiment, the kernel function may not be selectable. Example kernel functions include a uniform kernel function, a triangle kernel function, an Epanechnikov kernel function, a quartic (biweight) kernel function, a tricube kernel function, a triweight kernel function, a Gaussian kernel function, a quadratic kernel function, a cosine kernel function, a Gaussian radial basis kernel function, a polynomial kernel function, and a sigmoid (hyperbolic tangent) kernel function, a linear kernel function, a spline kernel function, a Laplacian kernel function, ANOVA radial basis kernel function, a Bessel kernel function, a string kernel function, etc.

In an operation 208, a range of kernel parameter values to evaluate is identified. For example, an indicator of the range of kernel parameter values may be received that includes a minimum kernel parameter value, a maximum kernel parameter value, and an incremental kernel parameter value. The incremental kernel parameter value is used for incrementing from the minimum to the maximum number kernel parameter value or vice versa. The incremental kernel parameter value may be or default to one or some other value. The indicator of the range of kernel parameter values may be received by incremental response modeling application 112 after selection from a user interface window or after entry by a user into a user interface window. Default values for the range of kernel parameter values to evaluate may further be stored, for example, in computer-readable medium 108 and identified by reading from the appropriate memory location. In an alternative embodiment, the range of kernel parameter values to evaluate may not be selectable.

One or more ranges of kernel parameter values may be identified dependent on the kernel function identified in operation 206. For example, if the Gaussian radial basis kernel function is identified in operation 206, the range of kernel parameter values identified includes a minimum value for a Gaussian kernel bandwidth, a maximum value for the Gaussian kernel bandwidth, and an incremental value for the Gaussian kernel bandwidth. As another example, if the polynomial kernel function is identified in operation 206, a first range of kernel parameter values identified includes a minimum value for a polynomial degree, a maximum value for the polynomial degree, and an incremental value for the polynomial degree; a second range of kernel parameter values identified includes a minimum value for a slope, a maximum value for the slope, and an incremental value for the slope; and a third range of kernel parameter values identified includes a minimum value for a constant term, a maximum value for the constant term, and an incremental value for the constant term. In an illustrative embodiment, the minimum value of the range may be equal to the maximum value of the range to define the kernel parameter value as a constant value.

In an operation 210, a range of upper bound parameter values to evaluate is identified. For example, an indicator of the range of upper bound parameter values may be received that includes a minimum upper bound parameter value, a maximum upper bound parameter value, and an incremental upper bound parameter value. The incremental upper bound parameter value is used for incrementing from the minimum to the maximum number upper bound parameter value or vice versa. The incremental upper bound parameter value may be or default to one or some other value. The indicator of the range of upper bound parameter values may be received by incremental response modeling application 112 after selection from a user interface window or after entry by a user into a user interface window. Default values for the range of upper bound parameter values to evaluate may further be stored, for example, in computer-readable medium 108 and identified by reading from the appropriate memory location. In an alternative embodiment, the range of upper bound parameter values to evaluate may not be selectable. For illustration, a value of upper bound parameter is greater than zero and less than or equal to one and defines an upper bound on a fraction of outliers and a lower bound on a fraction of support vectors.

In an operation 212, an upper bound parameter value is initialized. For example, the upper bound parameter value may be initialized to the minimum upper bound parameter value or the maximum upper bound parameter value defined in operation 210.

In an operation 214, a kernel parameter value is initialized. For example, each kernel parameter value identified in operation 208 may be initialized to the respective minimum kernel parameter value or the respective maximum kernel parameter value defined in operation 208.

In an operation 216, a one-class SVM is defined using the positive control group data. An SVM is essentially a two-class or binary classification algorithm. The one-class SVM is a modification of the binary SVM in which the origin is treated as an initial member of the second class. The one-class SVM identifies outliers in the first class. Given a training set of pairs (xᵢ, yᵢ) i=1, 2, . . . l where xᵢ ∈ [symbol] ⁿ and yᵢ ∈ {−1, 1}^{l}, the SVM that creates a soft margin separation hyper-plane classifying the positive and negative groups is determined by solving the optimization problem min_{w, b, ε}½w^{T}w+CΣᵢ₌₁^{l}εᵢ subject to yᵢ(w^{T}x+b)≧1−εᵢ, εᵢ≧0, where w is a normal vector to the hyper-plane,

$$\frac{b}{‖ w ‖}$$

determines an offset of the hyper-plane from the origin along the normal vector w, slack variables, εᵢ, measure a degree of misclassification of the data, and C is a penalty parameter.

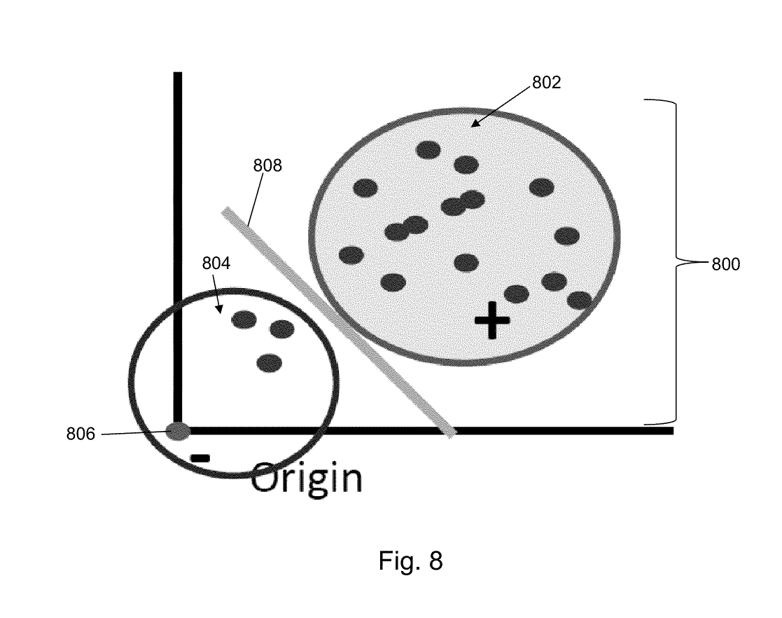

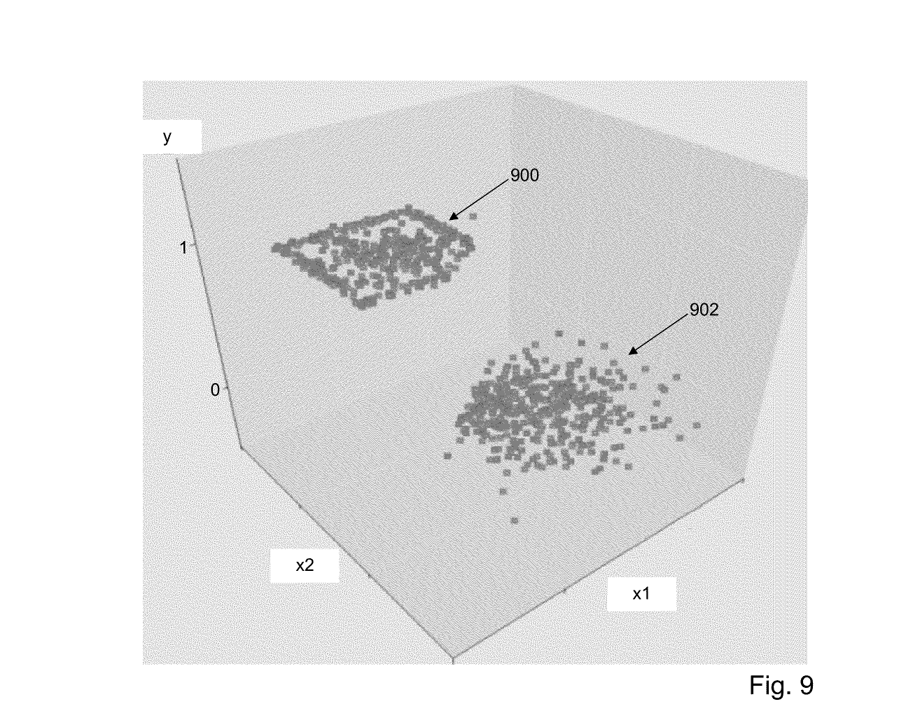

The one-class SVM model separates the identified positive responses from the control group data from an origin with a maximum margin. As an example, referring to FIG. 8, an illustration of defining the one-class SVM is shown. A sample dataset includes a plurality of points 800. The one-class SVM is defined to separate the plurality of points 800 into a first plurality of points 802 and a second plurality of points 804 closest to an origin 806 with a maximum margin. A line 808, the hyper-plane, is defined to separate the first plurality of points 802 and the second plurality of points 804 with the maximum margin.

In the context of one-class SVM, let x₁, x₂, . . . xₗ be training samples belonging to one-class x, where x is a compact subset of [symbol] ⁿ. Let Φ be a feature map: χ→F, i.e. Φ is a map transferring the identified positive control group data into an inner product space F. Φ can be computed by evaluating the identified kernel function K(x, y)=(Φ(x)·Φ(y)). For example, using the Gaussian radial basis kernel function, K(xᵢ, xⱼ)=exp(−γ∥xᵢ−xⱼ∥²), for γ>0, and γ=½σ², where σ is a Gaussian kernel bandwidth. The range of possible values to use for the Gaussian kernel bandwidth is identified in operation 208.

The one-class SVM strategy is to separate the data from origin 806 with maximum margin via mapping of the data into the feature space using the identified kernel function. To separate the data from origin 806, a quadratic programming problem

$${min}_{w ∈ F , ɛ ∈ {R}^{l} , ρ ∈ R} \frac{1}{2} {‖ w ‖}^{2} + \frac{1}{vl} {\sum }_{i = 1}^{l} {ɛ}_{i} - ρ$$

subject to (w·Φ(xᵢ))≦ρ−εᵢ, εᵢ≧0 is solved, where R is a real number line, l is a number of observations in the identified positive control group data, υ is the upper bound parameter value, xᵢ is an ith vector from the identified positive control group data associated with a positive response, and Φ(xᵢ) is a map transferring xᵢ into an inner product space F determined using the identified kernel function, and εᵢ is an ith slack variable. With a penalization of outliers using the slack variables εᵢ in the objective function, w and ρ are obtained by solving the quadratic programming problem. The one-class support vector machine model is defined using a decision function f(x)=sign((w·Φ(x))−ρ), wherein a negative value of f(x) identifies an outlier. And xᵢ includes one or more columns of dataset 114 associated with the respective positive respondent.

In an operation 218, a training error is determined for the defined one-class SVM. For illustration, the training error is determined as a proportion of outliers defined from the positive control group data. In an operation 220, the one-class SVM defined in operation 216 is executed with the positive exposure group data. In an operation 222, a validation error is determined for the defined one-class SVM executed in operation 220. For illustration, the validation error is determined as a proportion of outliers defined from the exposure group respondent data.

In an operation 224, a determination is made concerning whether or not the defined one-class SVM is validated. If the defined one-class SVM is not validated, processing continues in an operation 226. If the defined one-class SVM is validated, processing continues in an operation 228. For illustration, the defined one-class SVM is validated if a criterion is satisfied. For example, the criterion may be a minimum value of the validation error, a minimum value of the training error, a maximum value of a validation score defined as Vs=Verr−Terr, where Vs is the validation score, Verr is the determined validation error, and Terr is the determined training error, etc.

In an illustrative embodiment, a user may select the criterion used and a threshold value for the criterion to apply. A plurality of criteria may be used. For example, as part of initial processing, an indicator of which criterion to use and an associated threshold value may be received in a manner similar to the range of parameter values. The criterion may be satisfied if V≦T or if V≧T, where V is the value of the selected criterion such as the value of Vs, Verr, Terr and T is the associated threshold value. Whether the test uses ≦ or ≧ may depend on the selected criterion.

In operation 226, next iteration parameter value(s) are determined. For example, one or more of the initialized parameter values may be incremented. For illustration, one or more of the kernel parameter values is incremented based on the values identified in operation 208 and/or the upper bound parameter value is incremented based on the values identified in operation 210. A next iteration parameter value is defined by incrementing or decrementing a current parameter value from the minimum parameter value or the maximum parameter value, respectively, using the incremental parameter value. In an illustrative embodiment, a user may select an order of incrementing the parameter values. For example, as part of initial processing, an indicator of which kernel parameter to increment first, which to increment second, etc. Processing continues in operation 216 to define another one-class SVM with the iterated parameter values.

In an operation 228, a final one-class SVM is selected as the one-class SVM defined in the most recent iteration of operation 216. The most recent iteration of operation 216 may be the first iteration of operation 216.

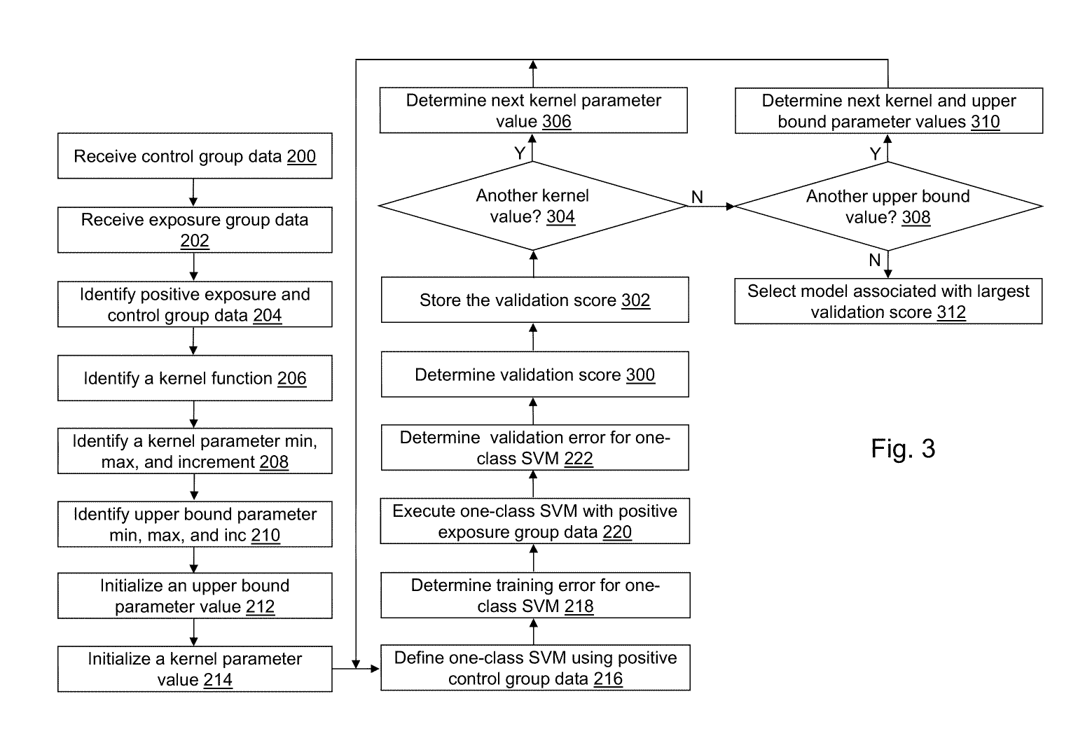

Referring to FIG. 3, example operations associated with incremental response modeling application 112 are described in accordance with a second illustrative embodiment. Additional, fewer, or different operations may be performed depending on the embodiment. The order of presentation of the operations of FIG. 3 is not intended to be limiting. Although some of the operational flows are presented in sequence, the various operations may be performed in various repetitions, concurrently, and/or in other orders than those that are illustrated.

The example operations shown referring to FIG. 3 include operations 200-222. After operation 222, in an operation 300, the validation score is determined. In an operation 302, the validation score is stored in association with the parameter values used in the one-class SVM defined in operation 216. For example, the validation score is stored in computer-readable medium 108 in association with the parameter value(s) of the identified kernel function and the upper bound parameter value.

In an operation 304, a determination is made concerning whether or not another iteration of the kernel parameter value is to be executed with a next kernel parameter value. For example, the determination may compare the current defined kernel parameter value to the minimum kernel parameter value or the maximum kernel parameter value to determine if each iteration has been executed as understood by a person of skill in the art. If another iteration is to be executed, processing continues in an operation 306. If each of the iterations has been executed, processing continues in an operation 308. A plurality of kernel parameter values may be considered in operation 304.

In operation 306, a next kernel parameter value is defined by incrementing or decrementing the current defined kernel parameter value using the incremental value. Processing continues in operation 216 to define the one-class SVM using the control group respondent data and the next kernel parameter value.

In an operation 308, a determination is made concerning whether or not another iteration of the upper bound parameter value is to be executed with a next upper bound parameter value. For example, the determination may compare the current defined upper bound parameter value to the minimum upper bound parameter value or the maximum upper bound parameter value to determine if each iteration has been executed as understood by a person of skill in the art. If another iteration is to be executed, processing continues in an operation 310. If each of the iterations has been executed, processing continues in an operation 312.

In operation 310, a next upper bound parameter value is defined by incrementing or decrementing the current defined upper bound parameter value using the incremental value. Processing continues in operation 216 to define the one-class SVM using the control group respondent data and the next upper bound parameter value.

In operation 312, a final one-class SVM is selected as the one-class SVM having the largest validation score.

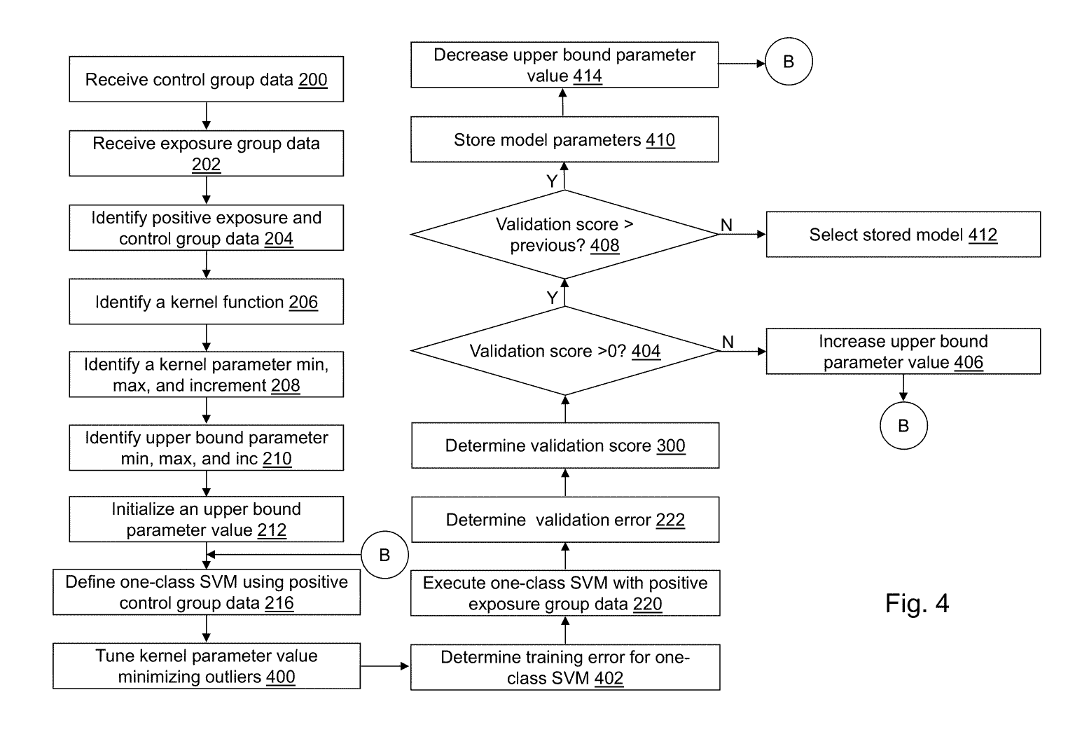

Referring to FIG. 4, example operations associated with incremental response modeling application 112 are described in accordance with a third illustrative embodiment. Additional, fewer, or different operations may be performed depending on the embodiment. The order of presentation of the operations of FIG. 4 is not intended to be limiting. Although some of the operational flows are presented in sequence, the various operations may be performed in various repetitions, concurrently, and/or in other orders than those that are illustrated.

The example operations shown referring to FIG. 4 include operations 200-212 and 216. After operation 216, in an operation 400, a kernel parameter value is tuned by minimizing the number of outliers identified. For example, in operation 400 the one-class SVM may be executed with the kernel parameter value defined for each value defined by the range of kernel parameter values defined in operation 208 to select the kernel parameter value that results in a minimum training error.

In operation 402, the training error is determined as the training error associated with execution of the one-class SVM with the tuned kernel parameter value from operation 400. Operations 220, 222, and 300 are performed.

After operation 300, in an operation 404, a determination is made concerning whether or not the validation score is greater than zero. If the validation score is not greater than zero, processing continues in an operation 406. If the validation score is greater than zero, processing continues in an operation 408.

In operation 406, a next upper bound parameter value is defined by incrementing the current defined upper bound parameter value using the incremental value. Processing continues in operation 216 to define the one-class SVM using the positive control group data and the next upper bound parameter value.

In an operation 408, a determination is made concerning whether or not the validation score is greater than a previous value of the validation score. If the validation score is greater than the previous value of the validation score, processing continues in an operation 410. If the validation score is not greater than the previous value of the validation score, processing continues in an operation 412.

In operation 410 the parameter values associated with the current defined one-class SVM are stored. For example, the kernel parameter value, the upper bound parameter value, and the validation score are stored in computer-readable medium 108. In operation 414, a next upper bound parameter value is defined by decrementing the current defined upper bound parameter value using the incremental value. Processing continues in operation 216 to define the one-class SVM using the positive control group data and the next upper bound parameter value.

In operation 412, a final one-class SVM is selected as the one-class SVM stored in the most recent iteration of operation 410.

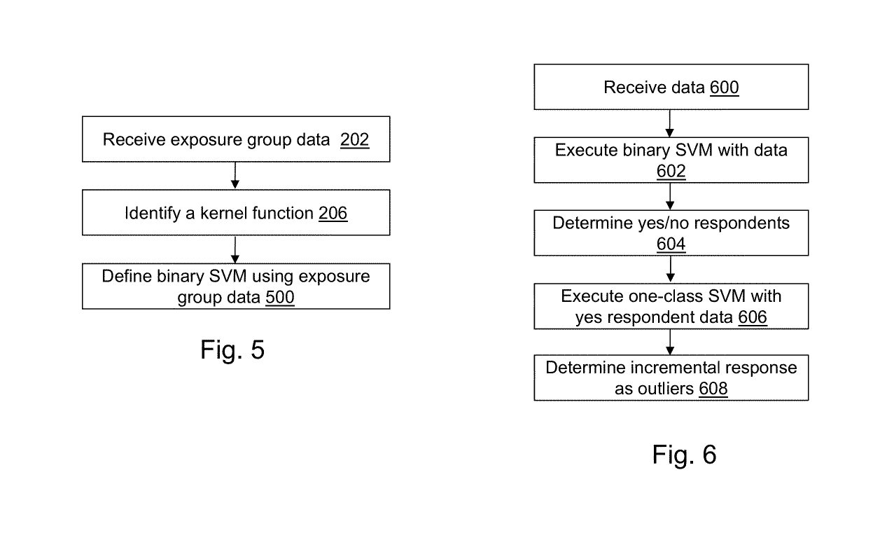

Referring to FIG. 5, example operations associated with incremental response modeling application 112 to determine a binary SVM are shown in accordance with an illustrative embodiment. Additional, fewer, or different operations may be performed depending on the embodiment. The order of presentation of the operations of FIG. 5 is not intended to be limiting. Although some of the operational flows are presented in sequence, the various operations may be performed in various repetitions, concurrently, and/or in other orders than those that are illustrated.

The example operations shown referring to FIG. 5 include operations 202-206. After operation 206, in an operation 500, a binary SVM is defined using the exposure group respondent data.

Referring to FIG. 6, example operations associated with incremental response modeling application 112 to determine an incremental response in data are shown in accordance with an illustrative embodiment. Additional, fewer, or different operations may be performed depending on the embodiment. The order of presentation of the operations of FIG. 6 is not intended to be limiting. Although some of the operational flows are presented in sequence, the various operations may be performed in various repetitions, concurrently, and/or in other orders than those that are illustrated.

In an operation 600, data in which to identify an incremental response is received. As an example, the data may be selected by a user using a user interface window and received by incremental response modeling application 112 by reading one or more files, through one or more user interface windows, etc. An indicator of the data that indicates the location of dataset 114 may be received. The indicator may be received by incremental response modeling application 112 after selection from a user interface window or after entry by a user into a user interface window. The data may be stored in computer-readable medium 108 and received by retrieving the data from the appropriate memory location as understood by a person of skill in the art. A subset of the data points (columns) for each observation in the received data may be used to determine the incremental response.

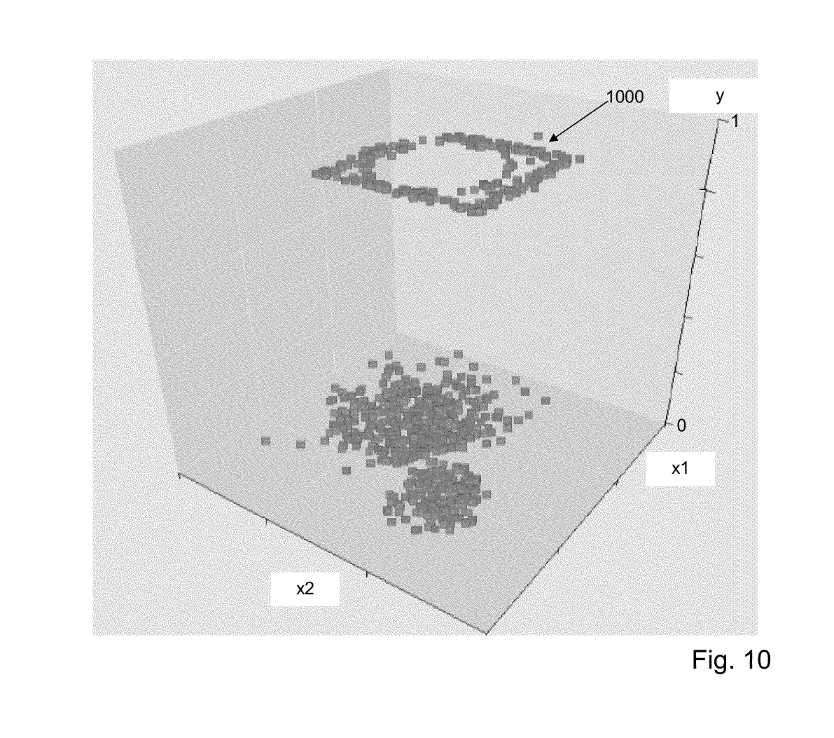

In an operation 602, the binary SVM defined in operation 500 is executed with the received data. In an operation 604, positive and negative respondents are determined from execution of the binary SVM. For example, the positive respondent data is separated from the negative respondent data. Referring to FIG. 9, an illustration of positive respondent data 900 separated from negative respondent data 902 is shown in accordance with an illustrative embodiment.

In an operation 606, the one-class SVM defined in one of operations 228, 312, or 412 is executed with the positive respondent data. In an operation 608, the incremental response is determined as the outliers that result from execution of the one-class SVM. Referring to FIG. 10, respondents 1000 are determined as the incremental response in accordance with an illustrative embodiment.

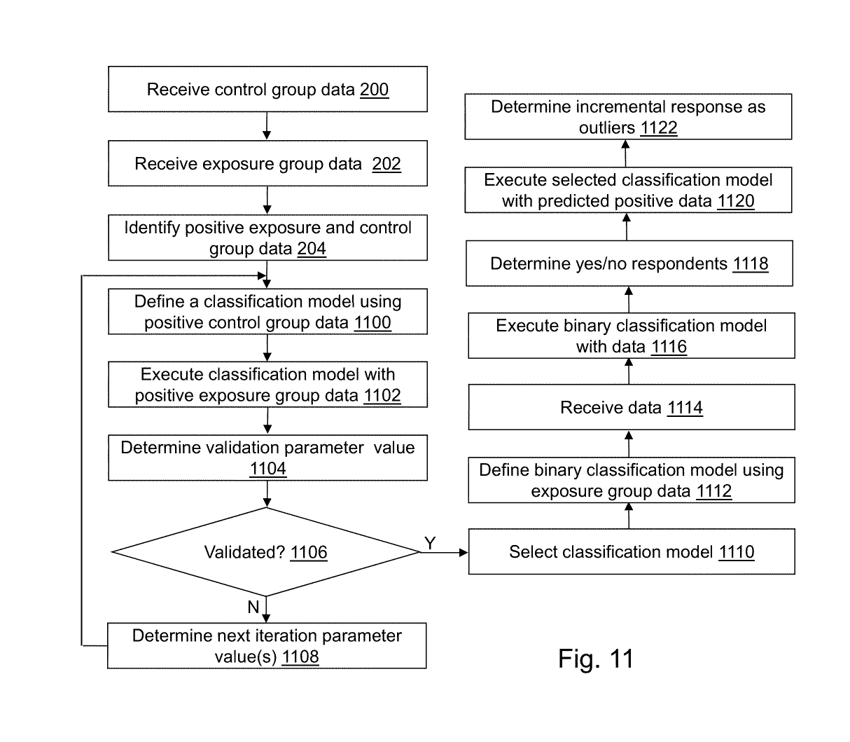

Referring to FIG. 11, example operations associated with incremental response modeling application 112 to determine an incremental response in data are shown in accordance with a second illustrative embodiment. Additional, fewer, or different operations may be performed depending on the embodiment. The order of presentation of the operations of FIG. 11 is not intended to be limiting. Although some of the operational flows are presented in sequence, the various operations may be performed in various repetitions, concurrently, and/or in other orders than those that are illustrated.

The example operations shown referring to FIG. 11 include operations 200-204. After operation 204, in an operation 1100, a classification model is defined using the positive control group data. For example, the classification model may be a one-class SVM. In an operation 1102, the defined classification model is executed with the positive exposure group data. In an operation 1104, a validation parameter value is determined. For example, the validation parameter value may be the training error, the validation error, the validation score, etc.

Similar to operation 224, in an operation 1106, a determination is made concerning whether or not the defined classification model is validated. If the defined classification model is not validated, processing continues in an operation 1108. If the defined classification model is validated, processing continues in an operation 1110. Similar to operation 226, in an operation 1108, next iteration parameter values are determined. Similar to operation 228, in an operation 1110, a final classification model is selected.

In an operation 1112, a binary classification model is defined using the exposure group data. For example, the binary classification model may be a binary SVM. Similar to operation 600, in an operation 1114, data in which to identify an incremental response is received. In an operation 1116, the binary classification model defined in operation 1112 is executed with the received data. In an operation 1118, positive and negative respondents are determined from execution of the binary SVM. For example, the positive respondent data is separated from the negative respondent data. In an operation 1120, the final classification model defined in operation 1110 is executed with the positive respondent data. In an operation 1122, the incremental response is determined as the outliers that result from the execution of the final classification model.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. For example, Apache™ Hadoop® is an open-source software framework for distributed computing.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” is intended to include “and/or” unless specifically indicated otherwise. The illustrative embodiments may be implemented as a method, apparatus, or article of manufacture using standard programming and/or engineering techniques to produce software, firmware, hardware, or any combination thereof to control a computer to implement the disclosed embodiments.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated. It is intended that the scope of the disclosed subject matter be defined by the claims appended hereto and their equivalents.

What is claimed is:

1. A non-transitory computer-readable medium having stored thereon computer-readable instructions that when executed by a computing device cause the computing device to:
receive exposure group data generated from first responses by an exposure group, wherein the exposure group received a request to respond, wherein a response of the first responses is either positive or negative;
receive control group data generated from second responses by a control group, wherein the control group did not receive the request to respond, wherein a response of the second responses is either positive or negative;
identify the positive responses in the control group data;
identify the positive responses in the exposure group data;
(a) define a one-class support vector machine (SVM) model using the identified positive responses from the control group data and an upper bound parameter value;
(b) execute the defined one-class SVM model with the identified positive responses from the exposure group data;
(c) determine an error value based on execution of the defined one-class SVM; and
(d) select a final one-class SVM model by validating the defined one-class SVM model using the determined error value.

2. The computer-readable medium of claim 1, wherein the defined one-class SVM model separates the identified positive responses from the control group data from an origin with a maximum margin.

3. The computer-readable medium of claim 1, wherein the one-class SVM model is defined by solving a quadratic programming problem
$${min}_{w ∈ F , ɛ ∈ {R}^{l} , ρ ∈ R} \frac{1}{2} {‖ w ‖}^{2} + \frac{1}{vl} {\sum }_{i = 1}^{l} {ɛ}_{i} - ρ$$
subject to (w·Φ((xᵢ))≧ρ−εᵢ, εᵢ≧0, where R is a real number line, l is a number of the positive responses in the control group data, υ is the upper bound parameter value, xᵢ is an ith vector from the control group data associated with a positive response, and Φ(xᵢ) is a map transferring xᵢ into an inner product space F determined using a kernel function, εᵢ is an ith slack variable, and w and ρ are obtained by solving the quadratic programming problem.

4. The computer-readable medium of claim 3, wherein the kernel function is selected from the group consisting of a Gaussian radial basis kernel function, a polynomial kernel function, and a sigmoid kernel function.

5. The computer-readable medium of claim 3, wherein the one-class SVM model is defined using a decision function f(x)=sign((w·Φ(x))−ρ), wherein a negative value of f(x) identifies an outlier.

6. The computer-readable medium of claim 1, wherein validating the one-class SVM model comprises comparing the error value to a threshold value.

7. The computer-readable medium of claim 6, wherein the error value is a training error determined by identifying outliers from the identified positive responses from the control group data.

8. The computer-readable medium of claim 6, wherein the error value is a validation error determined by identifying outliers from the identified positive responses from the exposure group data and by determining a proportion of the identified outliers that are in response to the request to respond.

9. The computer-readable medium of claim 6, wherein the error value is a validation score determined as Verr−Terr, where Verr is determined by identifying outliers from the identified positive responses from the exposure group data and by determining a proportion of the identified outliers that are in response to the request to respond, and Terr is determined by identifying outliers from the identified positive responses from the control group data.

10. The computer-readable medium of claim 1, wherein the error value is a validation score determined as Verr−Terr, where Verr is determined by identifying outliers from the identified positive responses from the exposure group data and by determining a proportion of the identified outliers that are in response to the request to respond, and Terr is determined by identifying outliers from the identified positive responses from the control group data.

11. The computer-readable medium of claim 5, wherein the computer-readable instructions further cause the computing device to, after (a) and before (b), (e) tune a kernel parameter value associated with the kernel function by minimizing a number of outliers identified from the identified positive responses from the control group data

12. The computer-readable medium of claim 11, wherein the error value is a validation score determined as Verr−Terr, where Verr is determined by identifying outliers from the identified positive responses from the exposure group data and by determining a proportion of the identified outliers that are in response to the request to respond, and Terr is determined by identifying outliers from the identified positive responses from the control group data.

13. The computer-readable medium of claim 12, wherein validating the one-class SVM model comprises computer-readable instructions that further cause the computing device to:
increment the upper bound parameter value and repeat (a), (b), (c), and (e) when the determined validation score is less than zero;
wherein the final one-class SVM model is selected as the one-class SVM model defined when the determined validation score is greater than zero and is greater than the determined validation score of a previous iteration of (a), (b), (c), and (e).

14. The computer-readable medium of claim 12, wherein validating the one-class SVM model comprises computer-readable instructions that further cause the computing device to:
determine if the determined validation score is greater than or equal to the determined validation score of a previous iteration of (a), (b), (c), and (e) when the determined validation score is greater than zero; and
decrement the upper bound parameter value and repeat (a), (b), (c), and (e) when the determined validation score is greater than zero and is greater than or equal to the determined validation score of a previous iteration of (a), (b), (c), and (e);
wherein the final one-class SVM model is selected as the one-class SVM model defined when the determined validation score is greater than zero and is greater than the determined validation score of a previous iteration of (a), (b), (c), and (e).

15. The computer-readable medium of claim 5, wherein the error value is a validation score determined as Verr−Terr, where Verr is determined by identifying outliers from the identified positive responses from the exposure group data and by determining a proportion of the identified outliers that are in response to the request to respond, and Terr is determined by identifying outliers from the identified positive responses from the control group data.

16. The computer-readable medium of claim 15, wherein validating the one-class SVM model comprises computer-readable instructions that further cause the computing device to increment the upper bound parameter value and repeat (a), (b), and (c) until the upper bound parameter value exceeds a maximum upper bound parameter value.

17. The computer-readable medium of claim 16, wherein the final one-class SVM model is selected as the one-class SVM model associated with a maximum value of the determined validation score.

18. The computer-readable medium of claim 15, wherein validating the one-class SVM model comprises computer-readable instructions that further cause the computing device to:
(e) increment the upper bound parameter value and repeat (a), (b), and (c) until the upper bound parameter value exceeds a maximum upper bound parameter value.

19. The computer-readable medium of claim 18, wherein validating the one-class SVM model comprises computer-readable instructions that further cause the computing device to:
(f) increment a kernel parameter value associated with the kernel function and repeat (a), (b), (c), and (e) until the kernel parameter value exceeds a maximum kernel parameter value,
wherein the final one-class SVM model is selected as the one-class SVM model associated with a maximum value of the determined validation score.

20. The computer-readable medium of claim 19, wherein (f) is repeated for a plurality of kernel parameter values.

21. The computer-readable medium of claim 19, wherein the kernel function is selected from the group consisting of a Gaussian radial basis kernel function, a polynomial kernel function, and a sigmoid kernel function.

22. The computer-readable medium of claim 15, wherein validating the one-class SVM model comprises computer-readable instructions that further cause the computing device to:
(e) increment a kernel parameter value associated with the kernel function and repeat (a), (b), and (c) until the kernel parameter value exceeds a maximum kernel parameter value.

23. The computer-readable medium of claim 22, wherein validating the one-class SVM model comprises computer-readable instructions that further cause the computing device to:
(f) increment the upper bound parameter value and repeat (a), (b), (c), and (e) until the upper bound parameter value exceeds a maximum upper bound parameter value,
wherein the final one-class SVM model is selected as the one-class SVM associated with a maximum value of the determined validation score.

24. The computer-readable medium of claim 1, wherein validating the one-class SVM model comprises computer-readable instructions that further cause the computing device to increment the upper bound parameter value and repeat (a), (b), and (c), until the upper bound parameter value exceeds a maximum upper bound parameter value, wherein the error value is a validation score determined as Verr−Terr, where Verr is determined by identifying outliers from the identified positive responses from the exposure group data and by determining a proportion of the identified outliers that are in response to the request to respond, and Terr is determined by identifying outliers from the identified positive responses from the control group data, and further wherein the final one-class support vector machine model is selected as the one-class support vector machine model associated with a maximum value of the determined error value.

25. The computer-readable medium of claim 1, wherein the computer-readable instructions further cause the computing device to:
define a binary SVM model using the exposure group data;
execute the defined binary SVM model with received data to predict positive responses and negative responses;
execute the selected final one-class SVM model with the predicted positive responses to define outliers; and
determine an incremental response as the defined outliers, wherein the incremental response comprises respondents that provide a positive response only when the request to respond is received.

26. The computer-readable medium of claim 1, wherein the request to respond comprises at least one of an advertisement, a request to vote for a candidate, a request to vote on an issue, a solicitation, an offer, a promotion, and an invitation.

27. The computer-readable medium of claim 1, wherein the computer-readable instructions further cause the computing device to store the final one-class SVM model.

28. A computing device comprising:
a processor; and
a non-transitory computer-readable medium operably coupled to the processor, the computer-readable medium having computer-readable instructions stored thereon that, when executed by the processor, cause the computing device to
receive exposure group data generated from first responses by an exposure group, wherein the exposure group received a request to respond, wherein a response of the first responses is either positive or negative;
receive control group data generated from second responses by a control group, wherein the control group did not receive the request to respond, wherein a response of the second responses is either positive or negative;
identify the positive responses in the control group data;
identify the positive responses in the exposure group data;
(a) define a one-class support vector machine (SVM) model using the identified positive responses from the control group data and an upper bound parameter value;
(b) execute the defined one-class SVM model with the identified positive responses from the exposure group data;
(c) determine an error value based on execution of the defined one-class SVM; and
(d) select a final one-class SVM model by validating the defined one-class SVM model using the determined error value.

29. The computing device of claim 28, wherein the request to respond comprises at least one of an advertisement, a request to vote for a candidate, a request to vote on an issue, a solicitation, an offer, a promotion, and an invitation.

30. A method of selecting a one-class support vector machine model for incremental response modeling, the method comprising:
receiving exposure group data generated from first responses by an exposure group, wherein the exposure group received a request to respond, wherein a response of the first responses is either positive or negative;
receiving control group data generated from second responses by a control group, wherein the control group did not receive the request to respond, wherein a response of the second responses is either positive or negative;
identifying the positive responses in the control group data;
identifying the positive responses in the exposure group data;
(a) defining, by a computing device, a one-class support vector machine (SVM) model using the identified positive responses from the control group data and an upper bound parameter value;
(b) executing, by the computing device, the defined one-class SVM model with the identified positive responses from the exposure group data;
(c) determining, by the computing device, an error value based on execution of the defined one-class SVM model; and
(d) selecting, by the computing device, a final one-class SVM model by validating the defined one-class SVM model using the determined error value.

31. The method of claim 30, wherein the request to respond comprises at least one of an advertisement, a request to vote for a candidate, a request to vote on an issue, a solicitation, an offer, a promotion, and an invitation.

32. A non-transitory computer-readable medium having stored thereon computer-readable instructions that when executed by a computing device cause the computing device to:
receive exposure group data generated from first responses by an exposure group, wherein the exposure group received a request to respond, wherein a response of the first responses is either positive or negative;
receive control group data generated from second responses by a control group, wherein the control group did not receive the request to respond, wherein a response of the second responses is either positive or negative;
identify the positive responses in the control group data;
identify the positive responses in the exposure group data;
define a classification model using the identified positive responses from the control group data;
execute the defined classification model with the identified positive responses from the exposure group data;
determine an error value based on execution of the defined classification model;
select a final classification model by validating the defined classification model using the determined error value;
define a binary classification model using the exposure group data;
execute the defined binary classification model with received data to predict positive responses and negative responses;
execute the selected final classification model with the predicted positive responses of the received data to define outliers; and
determine an incremental response as the defined outliers, wherein the incremental response comprises respondents that provide a positive response only when the request to respond is received.

33. The computer-readable medium of claim 32, wherein the classification model is an outlier detection model, and the identified positive responses are outliers.

34. The computer-readable medium of claim 32, wherein the request to respond comprises at least one of an advertisement, a request to vote for a candidate, a request to vote on an issue, a solicitation, an offer, a promotion, and an invitation.

35. A computing device comprising:
a processor; and
a non-transitory computer-readable medium operably coupled to the processor, the computer-readable medium having computer-readable instructions stored thereon that, when executed by the processor, cause the computing device to
receive exposure group data generated from first responses by an exposure group, wherein the exposure group received a request to respond, wherein a response of the first responses is either positive or negative;
receive control group data generated from second responses by a control group, wherein the control group did not receive the request to respond, wherein a response of the second responses is either positive or negative;
identify the positive responses in the control group data;
identify the positive responses in the exposure group data;
define a classification model using the identified positive responses from the control group data;
execute the defined classification model with the identified positive responses from the exposure group data;
determine an error value based on execution of the defined classification model;
select a final classification model by validating the defined classification model using the determined error value;
define a binary classification model using the exposure group data;
execute the defined binary classification model with received data to predict positive responses and negative responses;
execute the selected final classification model with the predicted positive responses of the received data to define outliers; and
determine an incremental response as the defined outliers, wherein the incremental response comprises respondents that provide a positive response only when the request to respond is received.

36. The computing device of claim 35, wherein the request to respond comprises at least one of an advertisement, a request to vote for a candidate, a request to vote on an issue, a solicitation, an offer, a promotion, and an invitation.

37. A method of identifying outliers in data for incremental response modeling, the method comprising:
receiving exposure group data generated from first responses by an exposure group, wherein the exposure group received a request to respond, wherein a response of the first responses is either positive or negative;
receiving control group data generated from second responses by a control group, wherein the control group did not receive the request to respond, wherein a response of the second responses is either positive or negative;
identifying the positive responses in the control group data;
identifying the positive responses in the exposure group data;
defining, by a computing device, a classification model using the identified positive responses from the control group data;
executing, by the computing device, the defined classification model with the identified positive responses from the exposure group data;
determining, by the computing device, an error value based on execution of the defined classification model;
selecting, by the computing device, a final classification model by validating the defined classification model using the determined error value;
defining, by the computing device, a binary classification model using the exposure group data;
executing, by the computing device, the defined binary classification model with received data to predict positive responses and negative responses;
executing, by the computing device, the selected final classification model with the predicted positive responses of the received data to define outliers; and
determining, by the computing device, an incremental response as the defined outliers, wherein the incremental response comprises respondents that provide a positive response only when the request to respond is received.

38. The method of claim 37, wherein the request to respond comprises at least one of an advertisement, a request to vote for a candidate, a request to vote on an issue, a solicitation, an offer, a promotion, and an invitation.
